(19) United States
(12) Patent Application Publication
(10) Pub. No.: US 2022/0076873 A1
(43) Pub. Date: Mar. 10, 2022

(54) OPTICAL COMMUNICATION MODULE AND MULTILAYER COIL COMPONENT

(71) Applicant: Murata Manufacturing Co., Ltd., Kyoto-fu (JP)

(72) Inventors: Atsuo HIRUKAWA, Nagaokakyo-shi (JP); Shun TAKAI, Nagaokakyo-shi (JP); Kenjirou KOSHIJI, Nagaokakyo-shi (JP)

(73) Assignee: Murata Manufacturing Co., Ltd., Kyoto-fu (JP)

(21) Appl. No.: 17/461,644

(22) Filed: Aug. 30, 2021

(30) Foreign Application Priority Data
Sep. 9, 2020 (JP) 2020-151184

(51) Int. Cl. H01F 27/28; H01F 27/29; H01F 27/32; H01F 41/04

(52) U.S. Cl. CPC H01F 27/2804; H01F 27/29; H04B 10/501; H01F 41/043; H01F 2027/2809; H01F 27/32

(57) ABSTRACT

An optical communication module includes a substrate equipped with lands whose surfaces are formed of gold layers and a multilayer coil component mounted on the substrate. The multilayer coil component includes a multilayer body in which a plurality of insulating layers are stacked in a stacking direction, a coil inside the multilayer body, and outer electrodes that are on surfaces of the multilayer body and electrically connected to the coil. The outer electrodes include gold coatings located at outermost layers of the outer electrodes. The gold coatings of the outer electrodes are bonded to the gold layers of the lands of the substrate via gold-tin solder.

### CROSS-REFERENCE TO RELATED APPLICATION

This application claims benefit of priority to Japanese Patent Application No. 2020-151184, filed Sep. 9, 2020, the entire content of which is incorporated herein by reference.

### BACKGROUND

### Technical Field

The present disclosure relates to an optical communication module and a multilayer coil component.

### Background Art

Japanese Unexamined Patent Application Publication No. 2019-186255 discloses a multilayer coil component that includes a multilayer body formed by stacking a plurality of insulating layers and having a coil built into the inside thereof, and outer electrodes.

It is stated that this multilayer coil component has excellent high-frequency characteristics and the transmission coefficient S21 at 40 GHz and 50 GHz is greater than or equal to a specific value.

In optical communication modules, for example, a transmitter optical subassembly (TOSA) that has a light-emitting element such as a laser diode or an electro-absorption modulator integrated laser (EML) thereinside and that converts an electrical signal into an optical signal and then transmits the optical signal, a receiver optical subassembly (ROSA) that has a light-receiving element such as a photodiode thereinside and that converts a received optical signal into an electrical signal, and a bidirectional optical subassembly (BOSA) that incorporates the functions of both a TOSA and a ROSA are used.

Taking the case of a TOSA as an example, an example of the structure of an optical communication module will be described.

A lead terminal, through which electrical signals are transmitted (transferred), is inserted into the TOSA, and electrical signals are introduced into the TOSA. A substrate is provided inside the TOSA and an IC and a light-emitting element, which are electronic components used as electro-optical converters, are mounted on the substrate.

An electrical signal introduced to the TOSA is converted into an optical signal via a wiring line inside the substrate, the IC, and the light-emitting element.

The multilayer coil component disclosed in Japanese Unexamined Patent Application Publication No. 2019-186255 is used to prevent a high-frequency signal from flowing into a power supply line when a DC voltage is applied to a laser diode or the like in an optical communication module. The outer electrodes of the multilayer coil component each include a nickel coating and a tin coating, and the multilayer coil component is used by being mounted on a mother board, on which an optical communication module such as a TOSA is also mounted, and being electrically connected to wiring inside the TOSA.

The transfer rates of data used in optical communication have been increasing in recent years and there has been increasing demand to reduce losses in a frequency range of 60 GHz and higher. In this region, there is a problem that loss due to the effect of an inductance component caused by the wiring length of wiring connecting the multilayer coil component and the optical communication module to each other cannot be ignored.

### SUMMARY

The present disclosure provides an optical communication module that includes a multilayer coil component and in which loss in a high-frequency region is reduced.

An optical communication module of an embodiment of the present disclosure includes a substrate equipped with lands whose surfaces are formed of gold layers and a multilayer coil component mounted on the substrate. The multilayer coil component includes a multilayer body in which a plurality of insulating layers are stacked in a stacking direction and inside of which a coil is provided, and outer electrodes that are provided on surfaces of the multilayer body and that are electrically connected to the coil. The outer electrodes include gold coatings located at outermost layers of the outer electrodes. The gold coatings of the outer electrodes are bonded to the gold layers of the lands of the substrate via gold-tin solder.

A multilayer coil component of an embodiment of the present disclosure is a multilayer coil component that is mounted in an optical communication module of an embodiment of the present disclosure. The multilayer coil component includes a multilayer body in which a plurality of insulating layers are stacked in a stacking direction and inside of which a coil is provided, and outer electrodes that are provided on surfaces of the multilayer body and are electrically connected to the coil. The outer electrodes include gold coatings located at outermost layers of the outer electrodes.

According to the embodiment of the present disclosure, an optical communication module that includes a multilayer coil component and in which loss in a high-frequency region is reduced can be provided.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a schematic diagram illustrating the inside of an optical communication module of the present disclosure and surrounding structures;

FIG. 2 is a schematic diagram illustrating the inside of an optical communication module of the related art and surrounding structures;

FIG. 3 is a perspective view schematically illustrating an example of a multilayer coil component;

FIG. 4 is a sectional view schematically illustrating an example of a multilayer coil component;

FIG. 5 is an exploded schematic perspective view schematically illustrating the states of insulating layers constituting the multilayer coil component illustrated in FIG. 4; and

FIG. 6 is an exploded schematic plan view schematically illustrating the states of insulating layers constituting the multilayer coil component illustrated in FIG. 4.

### DETAILED DESCRIPTION

Hereafter, an optical communication module and a multilayer coil component of the present disclosure will be described.

However, the present disclosure is not limited to the following configurations and modes and the present disclosure can be applied with appropriate modifications within a range that does not alter the gist of the present disclosure. Combinations of two or more preferable configurations or modes of the present disclosure described hereafter are also included in the scope of the present disclosure.

A substrate that is provided in an optical communication module such as a TOSA is equipped with lands, the surfaces of which are formed of gold layers, and electronic components are mounted on the lands. Generally, electronic components are mounted on the lands using gold-tin solder.

The outer electrodes of the multilayer coil component disclosed in Japanese Unexamined Patent Application Publication No. 2019-186255 each include a nickel coating and a tin coating and it is not possible to mount an electronic component having these kind of outer electrodes on lands whose surfaces are formed of gold layers using gold-tin solder.

In other words, it is not possible to directly mount the multilayer coil component disclosed in Japanese Unexamined Patent Application Publication No. 2019-186255 on a substrate that is provided in an optical communication module and is equipped with lands whose surfaces are formed of gold layers. Therefore, the multilayer coil component has to be mounted outside this substrate and this results in the wiring length of wiring that connects the multilayer coil component and the optical communication module to each other becoming longer.

Therefore, in an optical communication module of the present disclosure, the inventors decided to use a multilayer coil component having outer electrodes in which gold coatings are located at the outermost layers of the outer electrodes.

If the outermost layers of the outer electrodes consist of gold coatings, the outer electrodes can be mounted on lands whose surfaces are formed of gold layers using gold-tin solder and therefore the multilayer coil component can be directly mounted on the substrate of the optical communication module. Therefore, the wiring length of wiring connecting the multilayer coil component and another constituent element of the optical communication module to each other can be shortened and loss caused by the inductance component of the wiring can be reduced. In other words, an optical communication module that includes a multilayer coil component and in which loss in a high-frequency region is reduced can be provided.

Hereafter, an exemplary embodiment of such an optical communication module will be described.

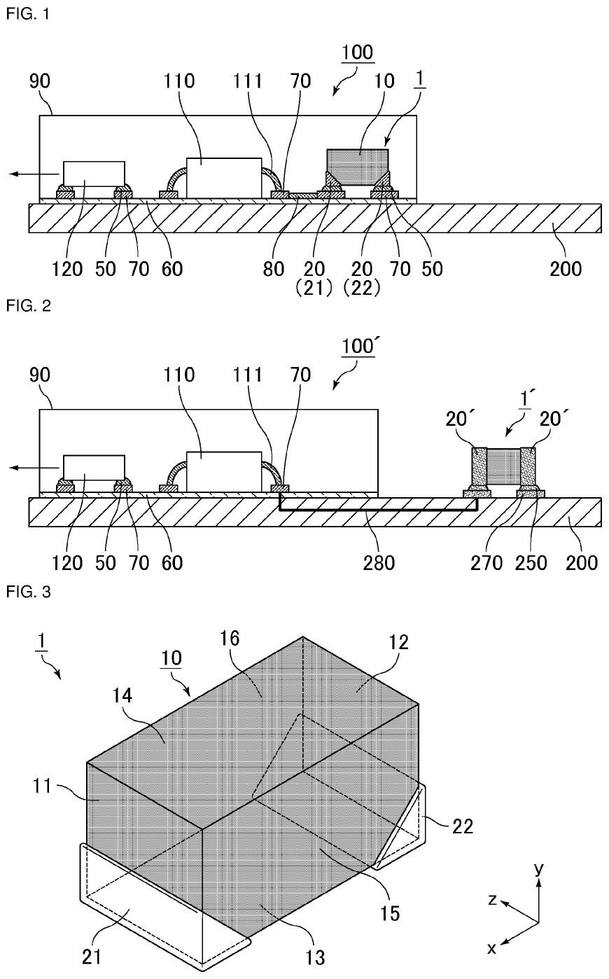

FIG. 1 is a schematic diagram illustrating the inside of an optical communication module of the present disclosure and surrounding structures.

An optical communication module 100 illustrated in FIG. 1 is mounted on a mother substrate 200. The optical communication module 100 has an outer body 90 whose bottom surface is formed by a substrate 60, and a multilayer coil component 1, an IC 110, and a laser diode 120 are mounted on the substrate 60. Since the optical communication module 100 includes the laser diode 120, which is a light-emitting element, the optical communication module 100 functions as a transmitter optical subassembly (TOSA).

The IC 110 and the laser diode 120 are electronic components other than the multilayer coil component 1 that are included in the optical communication module 100.

Note that in FIG. 1, the inside of the outer body 90 is schematically illustrated and an arrow is illustrated that represents emission of light from the laser diode 120.

The substrate 60 is equipped with lands 70 whose surfaces are formed of gold layers. The IC 110 and the laser diode 120 are mounted on the lands 70 of the substrate 60. Connections between the lands 70 and the IC 110 are formed by gold wires 111 and connections between the lands 70 and the laser diode 120 are formed by gold-tin solder 50. The forms of the connections between these electronic components and lands are not limited to the above-described forms.

The configuration of the lands 70, whose surfaces are formed of gold layers, of the substrate 60 are not particularly limited so long as their surfaces are formed of gold layers. It is preferable that there be a nickel layer below the gold layer. Solder erosion can be prevented when there is a nickel layer under the gold layer.

In addition, the lands 70 may be lands that are completely formed of gold layers. Furthermore, a nickel layer and a gold layer may be provided on top of a land composed of copper.

In addition to an IC and a laser diode, examples of electronic components mounted on the substrate 60 other than the multilayer coil component 1 include an LED element, a photodiode, a resistor, a capacitor, and so on.

If the optical communication module includes a light-receiving element such as a photodiode as an electronic component, the optical communication module will function as a receiver optical subassembly (ROSA).

In addition, if the optical communication module includes both a light-emitting element and a light-receiving element as electronic components, the optical communication module will function as a bidirectional optical subassembly (BOSA).

The multilayer coil component 1 is mounted on the substrate 60.

The structure of the multilayer coil component 1 will be described in detail later, but the multilayer coil component 1 includes a multilayer body 10, in which a plurality of insulating layers are stacked in a stacking direction and inside of which a coil is provided, and outer electrodes 20 that are provided on surfaces of the multilayer body 10 and are electrically connected to the coil.

The outer electrodes 20 include gold coatings that are located at the outermost layers of the outer electrodes 20. The configuration of the layers of the outer electrodes 20 will be described in detail later.

In addition, the multilayer coil component 1 includes a first outer electrode 21 and a second outer electrode 22 as the outer electrodes 20.

The gold coatings of the outer electrodes 20 of the multilayer coil component 1 are bonded to the gold layers forming the surfaces of the lands 70 of the substrate 60 via the gold-tin solder 50.

The multilayer coil component 1 can be bonded to the gold layers forming the surfaces of the lands 70 using the gold-tin solder 50 due to the outermost layers of the outer electrodes 20 of the multilayer coil component 1 consisting of gold coatings.

So long as the composition of the gold-tin solder contains gold and tin, the composition of the gold-tin solder is not particularly limited, and a composition such as Au82Sn18, Au80Sn20, Au79Sn21, Au78.5Sn21.5, or Au78Sn22 can be used.

If the multilayer coil component 1 can be bonded to the lands 70 whose surfaces are formed of gold layers, the multilayer coil component 1 can be disposed inside the optical communication module 100.

Therefore, the wiring length of wiring connecting the multilayer coil component 1 and another electronic component disposed inside the optical communication module 100 can be shortened.

In the optical communication module of the present disclosure, it is preferable that an electronic component other than the multilayer coil component be mounted on the substrate and that the electronic component and the multilayer coil component be mounted adjacent to each other.

In this specification, an electronic component and the multilayer coil component are regarded as being adjacent to each other when there are no other electronic components therebetween along a straight line connecting, with the shortest distance, a land of the multilayer coil component and a land of the electronic component, which are electrically connected to each other.

Since the wiring length of the wiring connecting the electronic component and the multilayer coil component to each other is short when the electronic component and the multilayer coil component are mounted adjacent to each other, loss caused by an inductance component of the wiring can be further reduced.

Furthermore, in the optical communication module of the present disclosure, an electronic component mounted adjacent to the multilayer coil component is preferably an IC.

FIG. 1 illustrates a state in which the multilayer coil component 1 is mounted adjacent to the IC 110, which is an electronic component. The wiring length of wiring connecting the multilayer coil component 1 and the IC 110 to each other is the length of wiring 80 that connects a land 70 on which the multilayer coil component 1 is mounted and a land 70 on which the IC 110 is mounted.

To enable comparison with the length of the wiring 80 illustrated in FIG. 1, the length of wiring between a multilayer coil component and an electronic component of an optical communication module of the related art will be described while referring to FIG. 2.

FIG. 2 is a schematic diagram illustrating the inside of the optical communication module of the related art and surrounding structures.

An optical communication module 100′ illustrated in FIG. 2 is mounted on a mother substrate 200. The multilayer coil component 1′ is mounted on the mother substrate 200 outside the optical communication module 100′.

The multilayer coil component 1′ differs from the multilayer coil component 1 illustrated in FIG. 1 with respect to the configuration of the outer electrodes and the outermost surfaces of outer electrodes 20′ of the multilayer coil component 1′ are formed of tin coatings.

The tin coatings of the outer electrodes 20′ of the multilayer coil component 1′ are bonded to lands 270 of the mother substrate 200 via solder 250.

Since the lands 270 of the mother substrate 200 are not lands whose surfaces are formed of gold layers, the lands 270 are bonded to the outer electrodes 20′ of the multilayer coil component 1′ using the solder 250, which is not gold-tin solder.

In the state illustrated in FIG. 2, the wiring length of wiring connecting the IC 110, which is an electronic component disposed inside the optical communication module 100′, and the multilayer coil component 1′ to each other is long. The wiring length of wiring connecting the multilayer coil component 1′ and the IC 110 to each other is the length of wiring 280 that connects a land 270 on which the multilayer coil component 1′ is mounted and a land 70 on which the IC 110 is mounted.

If we compare the length of the wiring 80 illustrated in FIG. 1 and the length of the wiring 280 illustrated in FIG. 2, the wiring 80 illustrated in FIG. 1 is shorter. In other words, loss caused by the inductance component of the wiring can be reduced by an amount proportional to this reduction in length.

The optical communication module of the present disclosure has this configuration and is therefore a communication module in which loss is reduced in a high-frequency region. This optical communication module is particularly suitable for use in a frequency range of 60 GHz and higher.

Next, a multilayer coil component that can be used in the optical communication module of the present disclosure will be described.

The multilayer coil component described hereafter is also a multilayer coil component of the present disclosure.

A multilayer coil component of an embodiment of the present disclosure is a multilayer coil component that is mounted in an optical communication module of an embodiment of the present disclosure. The multilayer coil component includes a multilayer body in which a plurality of insulating layers are stacked in a stacking direction and inside of which a coil is provided, and outer electrodes that are provided on surfaces of the multilayer body and are electrically connected to the coil. The outer electrodes include gold coatings located at outermost layers of the outer electrodes.

FIG. 3 is a perspective view schematically illustrating an example of a multilayer coil component.

As illustrated in FIG. 3, the multilayer coil component 1 includes the multilayer body 10, the first outer electrode 21, and the second outer electrode 22. The multilayer body 10 has a substantially rectangular parallelepiped shape having six surfaces. The configuration of the multilayer body 10 will be described later, but the multilayer body 10 is formed by stacking a plurality of insulating layers in the stacking direction and has a coil provided thereinside. The first outer electrode 21 and the second outer electrode 22 are electrically connected to the coil.

In a multilayer coil component and a multilayer body described in the present specification, a length direction, a height direction, and a width direction are respectively taken to be an x direction, a y direction, and a z direction in FIG. 3. Here, the length direction (x direction), the height direction (y direction), and the width direction (z direction) are perpendicular to each other.

The length direction (x direction) is a direction that is parallel to the stacking direction.

As illustrated in FIG. 3, the multilayer body 10 has a first end surface 11 and a second end surface 12, which face each other in the length direction (x direction), a first main surface 13 and a second main surface 14, which face each other in the height direction (y direction) perpendicular to the length direction, and a first side surface 15 and a second side surface 16, which face each other in the width direction (z direction) perpendicular to the length direction and the height direction.

Although not illustrated in FIG. 3, corner portions and edge portions of the multilayer body 10 are preferably rounded. The term “corner portion” refers to a part of the multilayer body 10 where three surfaces intersect and the term “edge portion” refers to a part of the multilayer body 10 where two surfaces intersect.

The first outer electrode and the second outer electrode are outer electrodes that extend along a main surface of the multilayer body from at least part of each end surface of the multilayer body.

In the multilayer coil component 1 illustrated in FIG. 3, the first outer electrode 21 is disposed so as to cover part of the first end surface 11 of the multilayer body 10 and so as to extend from the first end surface 11 and cover part of the first main surface 13.

In FIG. 3, the height of the part of the first outer electrode 21 that covers the first end surface 11 of the multilayer body 10 is constant, but the shape of the first outer electrode 21 is not particularly limited so long as the first outer electrode 21 covers part of the first end surface 11 of the multilayer body 10. For example, the first outer electrode 21 may have an arch-like shape that increases in height from the ends toward the center thereof on the first end surface 11 of the multilayer body 10. In addition, the length of the part of the first outer electrode 21 that covers the first main surface 13 of the multilayer body 10 is constant, but the shape of the first outer electrode 21 is not particularly limited so long as the first outer electrode 21 covers part of the first main surface 13 of the multilayer body 10. For example, the first outer electrode 21 may have an arch-like shape that increases in length from the ends toward the center thereof on the first main surface 13 of the multilayer body 10.

As illustrated in FIG. 3, the first outer electrode 21 may be additionally disposed so as to extend from the first end surface 11 and the first main surface 13 and cover part of the first side surface 15 and part of the second side surface 16. In this case, the parts of the first outer electrode 21 covering the first side surface 15 and the second side surface 16 are preferably formed in a diagonal shape relative to both the edge portions that intersect the first end surface 11 and the edge portions that intersect the first main surface 13. However, the first outer electrode 21 does not have to be disposed so as to cover part of the first side surface 15 and part of the second side surface 16.

In the multilayer coil component 1 illustrated in FIG. 3, the second outer electrode 22 is disposed so as to cover part of the second end surface 12 of the multilayer body 10 and so as to extend from the second end surface 12 and cover part of the first main surface 13.

Similarly to the first outer electrode 21, the second outer electrode 22 covers a region of the second end surface 12 that includes the edge portion that intersects the first main surface 13.

Similarly to the first outer electrode 21, the shape of the second outer electrode 22 is not particularly limited so long as the second outer electrode 22 covers part of the second end surface 12 of the multilayer body 10. For example, the second outer electrode 22 may have an arch-like shape that increases in height from the ends toward the center thereof on the second end surface 12 of the multilayer body 10. Furthermore, the shape of the second outer electrode 22 is not particularly limited so long as the second outer electrode 22 covers part of the first main surface 13 of the multilayer body 10. For example, the second outer electrode 22 may have an arch-like shape that increases in length from the ends toward the center thereof on the first main surface 13 of the multilayer body 10.

Similarly to the first outer electrode 21, the second outer electrode 22 may be additionally disposed so as to extend from the second end surface 12 and the first main surface 13 and cover part of the first side surface 15 and part of the second side surface 16. In this case, the parts of the second outer electrode 22 covering the first side surface 15 and the second side surface 16 are preferably formed in a diagonal shape relative to both the edge portions that intersect the second end surface 12 and the edge portions that intersect the first main surface 13. However, the second outer electrode 22 does not have to be disposed so as to cover part of the first side surface 15 and part of the second side surface 16.

The first outer electrode 21 and the second outer electrode 22 are disposed in the manner described above, and therefore the first main surface 13 of the multilayer body 10 serves as a mounting surface when the multilayer coil component 1 is mounted on a substrate.

Furthermore, different from the form illustrated in FIG. 3, the first outer electrode may cover the entirety of the first end surface of the multilayer body and may extend from the first end surface and cover part of the first main surface, part of the second main surface, part of the first side surface, and part of the second side surface.

In addition, the second outer electrode may cover the entirety of the second end surface of the multilayer body and may extend from the second end surface and cover part of the first main surface, part of the second main surface, part of the first side surface, and part of the second side surface.

In this case, any one out of the first main surface, the second main surface, the first side surface, and the second side surface of the multilayer body may serve as a mounting surface.

The outer electrodes include gold coatings that are located at the outermost layers of the outer electrodes.

As described above, if the outermost layers of the outer electrodes are gold coatings, the outer electrodes can be bonded to the gold layers forming the surfaces of the lands using gold-tin solder.

Furthermore, the thickness of the gold coatings of the outer electrodes is preferably from around 0.4 μm to around 1.2 μm. Furthermore, the thickness of the gold coatings is more preferably around 0.7 μm or higher.

The outer electrodes preferably each include a nickel coating located nearer the multilayer body than the gold coating.

As a result of there being a nickel coating on the inner side (multilayer body side) of the gold coating, the nickel coating functions as a barrier layer and can prevent solder erosion. The term “solder erosion” used here refers to a phenomenon in which a layer (for example, a base electrode layer containing silver) that is nearer the inside than the nickel coating in the outer electrode melts away during soldering.

In the case where each outer electrode includes a nickel coating, the nickel coating preferably has a thickness of around 1.5 μm to around 4.5 μm.

The outer electrodes preferably include base electrode layers containing silver. The base electrode layers are preferably layers that contact the multilayer body.

As the configuration of each outer electrode, the nickel coating and the gold coating are preferably formed in this order on the base electrode layer.

The bonding strength between the multilayer body and the outer electrodes is high due to the inclusion of the base electrode layers in the outer electrodes, and therefore the bonding strength between the multilayer body and the outer electrodes can be increased.

Although the size of the multilayer coil component is not particularly limited, the multilayer coil component is preferably the 0603 size, the 0402 size, or the 1005 size.

The insulating layers preferably include a ferrite phase and a non-magnetic phase composed of a material having a lower dielectric constant than the ferrite material that constitutes the ferrite phase.

Furthermore, the insulating layers may include only a ferrite phase or may include only a non-magnetic phase.

The ferrite phase is a phase including a ferrite material and may be a phase consisting of only a ferrite material.

The ferrite phase is preferably composed of a Ni—Cu—Zn ferrite material. The inductance of the multilayer coil component is increased when the ferrite phase is composed of a Ni—Cu—Zn ferrite material.

The Ni—Cu—Zn ferrite material preferably contains Fe₂O₃ at around 40 mol % to around 49.5 mol %, ZnO at around 5 mol % to around 35 mol %, CuO at around 4 mol % to around 12 mol %, and the remainder NiO. These oxides may contain unavoidable impurities.

The Ni—Cu—Zn ferrite material may additionally contain additives such as Mn₃O₄, Bi₂O₃, Co₃O₄, and SnO₂.

Furthermore, the ferrite phase is a phase that contains Fe when subjected to elemental analysis, and preferably contains Fe, Zn, Cu, and Ni. In addition, the ferrite phase may additionally contain Mn, Bi, Co, Sn, and so on.

The ferrite phase preferably contains Fe at around 40 mol % to around 49.5 mol % in terms of Fe₂O₃, Zn at around 2 mol % to around 35 mol % in terms of ZnO, Cu at around 6 mol % to around 13 mol % in terms of CuO, and Ni at around 10 mol % to around 45 mol % in terms of NiO.

The non-magnetic phase is a phase composed of a material having a lower dielectric constant than the ferrite material.

Examples of the material constituting the non-magnetic phase include glass materials, forsterite (2MgO—SiO₂), and wilmite (aZnO-SiO₂ (where a lies in a range from around 1.8 to around 2.2)). As a glass material, borosilicate glass is preferred.

The borosilicate glass preferably contains Si at a ratio of around 80 wt % to around 85 wt % in terms of SiO₂, B at a ratio of around 10 wt % to around 25 wt % in terms of B₂O₃, an alkali metal A at a ratio of around 0.5 wt % to around 5 wt % in terms of A₂O, and Al at a ratio of around 0 wt % to around 5 wt % in terms of Al₂O₃. K, Na, or the like may be used as the alkali metal A.

The ferrite phase and the non-magnetic phase are distinguished as follows. First, a cross section of the multilayer body of the multilayer coil component along the stacking direction is exposed by grinding down the multilayer body and then elemental mapping is performed on the multilayer body by performing scanning transmission electron microscopy-energy dispersive X-ray analysis (STEM-EDX). Then, the two phases are distinguished from each other by regarding regions where the Fe element is present as making up the ferrite phase and regions other than the ferrite phase as making up the non-magnetic phase.

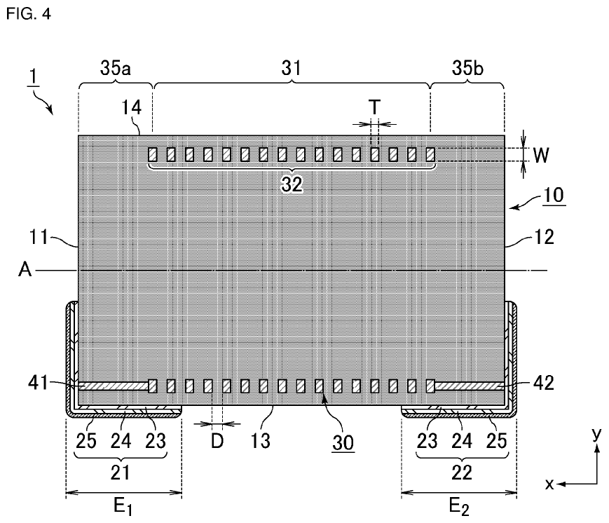

A cross section taken along the stacking direction is a cross section like that illustrated in FIG. 4 described later.

Regarding the ferrite phase and the non-magnetic phase distinguished in this way, the ferrite material making up the ferrite phase has a high dielectric constant and the material making up the non-magnetic phase has a lower dielectric constant than the ferrite material.

The relative dielectric constant of the ferrite material may be, for example, around 14.5 to around 15.5.

Furthermore, the relative dielectric constant of the material making up the non-magnetic phase is not particularly limited so long as the relative dielectric constant is lower than the relative dielectric constant of the ferrite material, but the relative dielectric constant of the material making up the non-magnetic phase is, for example, preferably less than or equal to around 7.0, and more preferably less than or equal to around 5.0.

The dielectric constant of the insulating layers forming the multilayer coil component is reduced due to the insulating layers containing the non-magnetic phase, which is composed of a material having a lower dielectric constant than the ferrite material. Loss in the multilayer coil component itself can be reduced by lowering the dielectric constant of the insulating layers.

The structural formula of the ferrite material constituting the ferrite phase is determined and the structural formula of the material constituting the non-magnetic phase is determined by performing the elemental mapping described above in order to determine the relative dielectric constant of the ferrite material and the relative dielectric constant of the material constituting the non-magnetic phase. Then, the relative dielectric constants of the compounds with these structural formulas are obtained from a publicly available database. The relative dielectric constant of the ferrite material and the relative dielectric constant of the material constituting the non-magnetic phase can be determined using this procedure.

In addition, a dielectric constant measurement test piece may be manufactured by molding the ferrite material into a prescribed shape and then forming electrodes on the test piece, and then the electrostatic capacitance of the test piece may be measured under prescribed conditions, and the relative dielectric constant of the ferrite material may be obtained on the basis of the measured value of the electrostatic capacitance and the dimensions of the dielectric constant measurement test piece. Similarly, the relative dielectric constant of the material constituting the non-magnetic phase may be obtained by manufacturing a dielectric constant measurement test piece by molding the material constituting the non-magnetic phase into a prescribed shape.

The ratio of the volume of the non-magnetic phase to the total volume of the ferrite phase and the non-magnetic phase is preferably around 55 vol % to around 80 vol %.

When the ratio of the volume of the non-magnetic phase to the total volume of the ferrite phase and the non-magnetic phase is less than around 55 vol %, the amount of material having a low relative dielectric constant is small, and therefore the effect of reducing loss in the high-frequency region is reduced by a corresponding amount.

On the other hand, when the ratio of the volume of the non-magnetic phase to the total volume of the ferrite phase and the non-magnetic phase is greater than around 80 vol %, the strength of the multilayer body may be inadequate due to the proportion of material made up of the non-magnetic phase being too high.

From the viewpoint of improving the high-frequency characteristics of the multilayer coil component, the ratio of the volume of the non-magnetic phase to the total volume of the ferrite phase and the non-magnetic phase is preferably around 60 vol % to around 80 vol %.

The ratio of the volume of the non-magnetic phase to the total volume of the ferrite phase and the non-magnetic phase is determined as follows. First, a cross section of the multilayer body of the multilayer coil component along the stacking direction is exposed by grinding down the multilayer body up to a center part thereof in a direction perpendicular to the stacking direction.

Next, the ferrite phase and the non-magnetic phase are distinguished from each other as described above by extracting three 50 μm square regions from the vicinity of the center of the exposed cross section and subjecting the regions to elemental mapping using scanning transmission electron microscopy-energy dispersive X-ray analysis. Then, the ratio of the area of the non-magnetic phase to the total area of the ferrite phase and the non-magnetic phase is measured using image analysis software from the obtained elemental mapping image for each of the three regions described above. After that, an average value is calculated from the measured values of these area ratios and this average value is taken to be the ratio of the volume of the non-magnetic phase to the total volume of the ferrite phase and the non-magnetic phase.

Furthermore, the ratio of the volume of forsterite to the total volume of the non-magnetic phase is preferably around 2 vol % to around 8 vol %.

The ratio of the volume of forsterite contained in the non-magnetic phase can be calculated by distinguishing regions where the element Mg, which is an element contained in forsterite, is present as regions where forsterite is present and measuring the ratio of the area of the regions where forsterite is present to the area of the non-magnetic phase.

The strength of the multilayer body is improved when around 2 vol % to around 8 vol % of the non-magnetic phase consists of forsterite.

The insulating layers preferably contain B at around 4.3 wt % to around 8.0 wt % in terms of B₂O₃, Si at around 27.6 wt % to around 51.4 wt % in terms of SiO₂, Mg at around 1.1 wt % to around 2.1 wt % in terms of MgO, Fe at around 24.7 wt % to around 43.5 wt % in terms of Fe₂O₃, Ni at around 3.3 wt % to around 5.9 wt % in terms of NiO, Zn at around 7.7 wt % to around 13.5 wt % in terms of ZnO, and Cu at around 2.0 wt % to around 3.6% in terms of CuO.

The composition of the insulating layers is confirmed by analysis performed using inductively coupled plasma atomic emission spectroscopy (ICP-AES).

Next, an example of a coil built into the multilayer body of the multilayer coil component will be described.

The coil is formed by electrically connecting a plurality of coil conductors, which are stacked in the stacking direction together with the insulating layers, to one another.

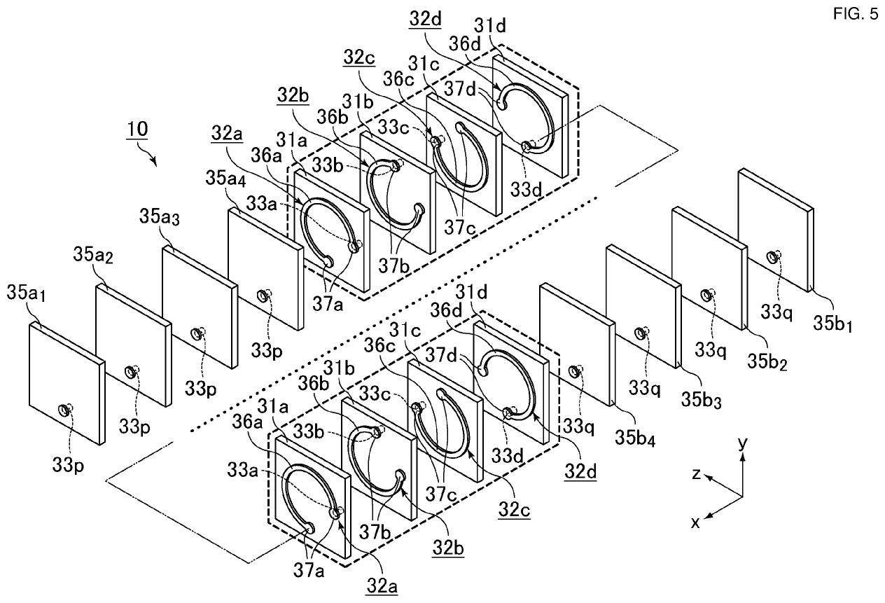

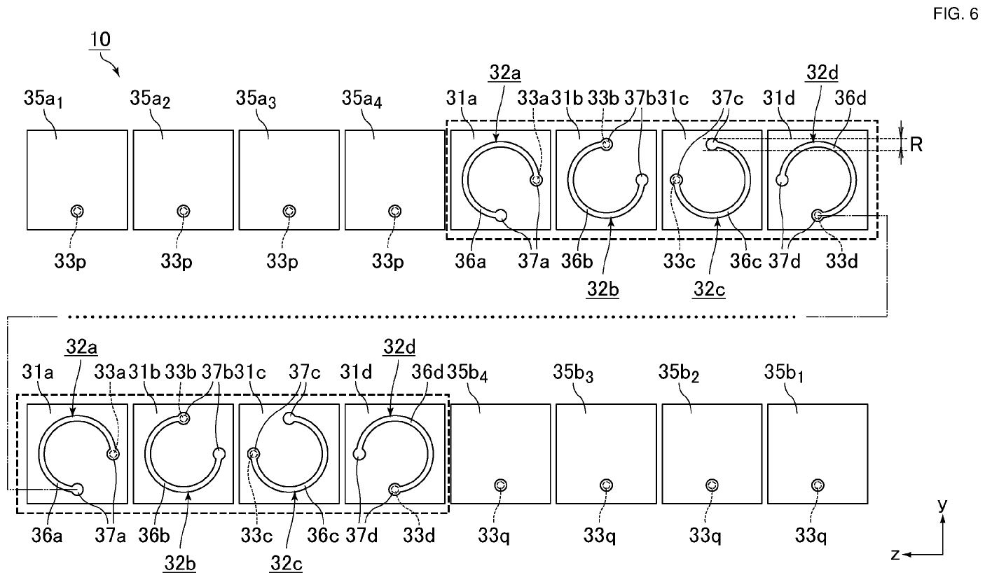

FIG. 4 is a sectional view schematically illustrating an example of a multilayer coil component, FIG. 5 is an exploded schematic perspective view schematically illustrating the states of insulating layers of the multilayer coil component illustrated in FIG. 4, and FIG. 6 is an exploded schematic plan view schematically illustrating the states of the insulating layers of the multilayer coil component illustrated in FIG. 4.

FIG. 4 illustrates insulating layers, coil conductors, connection conductors, and a stacking direction of the multilayer body in a schematic manner, and the actual shapes, connections, and so forth are not depicted with strict accuracy. For example, the coil conductors are connected to each other by via conductors.

As illustrated in FIG. 4, the multilayer coil component 1 includes: the multilayer body 10, which has a coil built into the inside thereof, that is formed by electrically connecting together a plurality of coil conductors 32 that are stacked together with insulating layers; and the first outer electrode 21 and the second outer electrode 22, which are electrically connected to the coil.

In FIG. 4, it is illustrated that the first outer electrode 21 and the second outer electrode 22 each include a base electrode layer 23 containing silver and that a nickel coating 24 and a gold coating 25 are formed in this order on the base electrode layer 23.

The multilayer body 10 includes a region in which the coil conductors 32 are disposed and regions in which a first connection conductor 41 and a second connection conductor 42 are arranged. The stacking direction of the multilayer body 10 and the axial direction of the coil (coil axis A illustrated in FIG. 4) are parallel to the first main surface 13.

As illustrated in FIGS. 5 and 6, the multilayer body 10 includes an insulating layer 31a, an insulating layer 31b, an insulating layer 31c, and an insulating layer 31d as insulating layers 31 in FIG. 4. The multilayer body 10 includes an insulating layer 35a₁, an insulating layer 35a₂, an insulating layer 35a₃, and an insulating layer 35a₄ as insulating layers 35a in FIG. 4. The multilayer body 10 includes an insulating layer 35b₁, an insulating layer 35b₂, an insulating layer 35b₃, and an insulating layer 35b₄ as insulating layers 35b in FIG. 4.

A coil 30 includes a coil conductor 32a, a coil conductor 32b, a coil conductor 32c, and a coil conductor 32d as the coil conductors 32 in FIG. 4.

The coil conductor 32a, the coil conductor 32b, the coil conductor 32c, and the coil conductor 32d are respectively disposed on main surfaces of the insulating layer 31a, the insulating layer 31b, the insulating layer 31c, and the insulating layer 31d.

The length of each of the coil conductors 32a, 32b, 32c, and 32d is the length of ¾ of a turn of the coil 30. In other words, four coil conductors are stacked on top of one another in order to form three turns of the coil 30. In the multilayer body 10, the coil conductor 32a, the coil conductor 32b, the coil conductor 32c, and the coil conductor 32d are repeatedly stacked as a single unit (three turns).

The coil conductor 32a includes a line portion 36a and a land portion 37a disposed at an end portion of the line portion 36a. The coil conductor 32b includes a line portion 36b and a land portion 37b disposed at an end portion of the line portion 36b. The coil conductor 32c includes a line portion 36c and a land portion 37c disposed at an end portion of the line portion 36c. The coil conductor 32d includes a line portion 36d and a land portion 37d disposed at an end portion of the line portion 36d.

A via conductor 33a, a via conductor 33b, a via conductor 33c, and a via conductor 33d are disposed so as to respectively penetrate through the insulating layer 31a, the insulating layer 31b, the insulating layer 31c, and the insulating layer 31d in the stacking direction.

The insulating layer 31a provided with the coil conductor 32a and the via conductor 33a, the insulating layer 31b provided with the coil conductor 32b and the via conductor 33b, the insulating layer 31c provided with the coil conductor 32c and the via conductor 33c, and the insulating layer 31d provided with the coil conductor 32d and the via conductor 33d are repeatedly stacked as a single unit (parts surrounded by dotted lines in FIGS. 5 and 6). Thus, the land portion 37a of the coil conductor 32a, the land portion 37b of the coil conductor 32b, the land portion 37c of the coil conductor 32c, and the land portion 37d of the coil conductor 32d are connected to each other by the via conductor 33a, the via conductor 33b, the via conductor 33c, and the via conductor 33d. In other words, the land portions of coil conductors that are adjacent to each other in the stacking direction are connected to each other by the via conductors.

The solenoid-shaped coil 30 built into the multilayer body 10 is formed in the above-described manner.

In plan view in the stacking direction, the coil 30 formed of the coil conductors 32a, the coil conductors 32b, the coil conductors 32c, and the coil conductors 32d may have a substantially circular shape or may have a substantially polygonal shape. In the case where the coil 30 has a substantially polygonal shape in plan view in the stacking direction, the coil diameter of the coil 30 is the diameter of an area-equivalent circle of the polygonal shape and the coil axis of the coil 30 is an axis that extends in the stacking direction through the center of the polygonal shape.

Via conductors 33p are disposed so as to penetrate in the stacking direction through the insulating layer 35a₁, the insulating layer 35a₂, the insulating layer 35a₃, and the insulating layer 35a4. Land portions connected to the via conductors 33p may be disposed on the main surfaces of the insulating layer 35a₁, the insulating layer 35a₂, the insulating layer 35a₃, and the insulating layer 35a₄.

The insulating layer 35a₁ provided with the via conductor 33p, the insulating layer 35a₂ provided with the via conductor 33p, the insulating layer 35a₃ provided with the via conductor 33p, and the insulating layer 35a₄ provided with the via conductor 33p are stacked so as to overlap the insulating layer 31a provided with the coil conductor 32a and the via conductor 33a. As a result, the via conductors 33p are connected to each other and form the first connection conductor 41 and the first connection conductor 41 is exposed at the first end surface 11. As a result, the first outer electrode 21 and the coil 30 are connected to each other via the first connection conductor 41.

As described above, the first connection conductor 41 is preferably connected in a straight line between the first outer electrode 21 and the coil 30. The phrase “the first connection conductor 41 is connected in a straight line between the first outer electrode 21 and the coil 30” means that the via conductors 33p forming the first connection conductor 41 overlap one another in plan view in the stacking direction and it is not necessary for the via conductors 33p to be perfectly aligned in a straight line.

Via conductors 33q are disposed so as to penetrate in the stacking direction through the insulating layer 35b₁, the insulating layer 35b₂, the insulating layer 35b₃, and the insulating layer 35b₄. Land portions connected to the via conductors 33q may be disposed on the main surfaces of the insulating layer 35b₁, the insulating layer 35b₂, the insulating layer 35b₃, and insulating layer 35b₄.

The insulating layer 35b₁ provided with the via conductor 33q, the insulating layer 35b₂ provided with the via conductor 33q, the insulating layer 35b₃ provided with the via conductor 33q, and the insulating layer 35b₄ provided with the via conductor 33q are stacked so as to overlap the insulating layer 31d provided with the coil conductor 32d and the via conductor 33d. As a result, the via conductors 33q are connected to each other and form the second connection conductor 42 and the second connection conductor 42 is exposed at the second end surface 12. As a result, the second outer electrode 22 and the coil 30 (coil conductor 32d) are connected to each other via the second connection conductor 42.

As described above, the second connection conductor 42 is preferably connected in a straight line between the second outer electrode 22 and the coil 30. The phrase “the second connection conductor 42 is connected in a straight line between the second outer electrode 22 and the coil 30” means that the via conductors 33q forming the second connection conductor 42 overlap one another in plan view in the stacking direction and it is not necessary for the via conductors 33q to be perfectly aligned in a straight line.

In the case where land portions are connected to the via conductors 33p forming the first connection conductor 41 and the via conductors 33q forming the second connection conductor 42, the shape of the first connection conductor 41 and the shape of the second connection conductor 42 refer to the shapes without the land portions.

In FIGS. 5 and 6, a case is exemplified in which four coil conductors are stacked in order to form three turns of the coil 30, i.e., the repeating shape is the shape of ¾ of a turn, but the number of coil conductors that are stacked in order to form one turn of the coil is not particularly limited.

For example, the number of coil conductors stacked in order to form one turn of the coil may be two, i.e., the repeating shape may be the shape of ½ a turn.

The coil conductors forming the coil preferably overlap in plan view in the stacking direction. In addition, the coil preferably has a substantially circular shape in plan view in the stacking direction. In the case where the coil includes land portions, the shape of the coil is taken to be the shape obtained by removing the land portions (i.e., the shape of the line portions).

In addition, in the case where land portions are connected to the via conductors forming the connection conductors, the shape of the connection conductors is the shape obtained by removing the land portions (i.e., the shape of the via conductors).

The coil conductors illustrated in FIG. 5 are shaped so that the repeating pattern has a substantially circular shape, but the coil conductors may instead be shaped so that the repeating pattern has a substantially polygonal shape such as a substantially quadrangular shape.

In addition, the repeating shape of the coil conductors may be a ½ turn shape rather than a ¾ turn shape.

In a multilayer coil component having the configuration illustrated in FIGS. 4, 5, and 6, when the size of the multilayer coil component is the 0603 size, the multilayer coil component is preferably designed as follows in order to further improve the high-frequency characteristics.

The number of turns of the coil is preferably around 36 turns to around 42 turns. When the number of turns lies in this range, the total electrostatic capacitance between the coil conductors can be reduced and therefore the high-frequency characteristics can be improved.

In addition, the coil length is preferably around 0.41 mm to around 0.48 mm.

The width of the coil conductors is preferably around 45 μm to around 75 μm. The width of the coil conductors is a dimension indicated by double arrows W in FIG. 4.

The thickness of the coil conductors is preferably around 3.5 μm to around 6.0 μm. The thickness of the coil conductors is a dimension indicated by double arrows T in FIG. 4.

The distance between the coil conductors is preferably around 3.0 μm to around 5.0 μm. The distance between the coil conductors is a dimension indicated by double arrows D in FIG. 4.

The diameter of the land portions of the coil conductors is preferably around 30 μm to around 50 μm. The diameter of the land portions of the coil conductors is a dimension indicated by double arrows R in FIG. 6.

When the first main surface of the multilayer body is used as the mounting surface, the length of the part of the first outer electrode that covers the first main surface of the multilayer body and the length of the part of the second outer electrode that covers the first main surface of the multilayer body are preferably around 0.20 mm or lower. Furthermore, these lengths are preferably around 0.10 mm or higher.

The length of the part of the first outer electrode covering the first main surface of the multilayer body and the length of the part of the second outer electrode covering the first main surface of the multilayer body are dimensions respectively indicated by double arrows E₁ and double arrows E₂ in FIG. 4.

Furthermore, the relative dielectric constant of the insulating layers constituting the multilayer coil component is preferably around 8.5 or lower. In addition, the relative dielectric constant is preferably around 8.0 or lower and may be around 6.5 or higher.

The relative dielectric constant of the insulating layers constituting the multilayer coil component can be measured in the following manner.

A dielectric constant measurement test piece is fabricated by molding an insulating layer into a prescribed shape (for example, a disk shape). Electrodes are formed on the test piece, and then the electrostatic capacitance is measured under conditions of a frequency of 1 MHz and a voltage of 1 Vrms. The relative dielectric constant is calculated from the diameter and thickness of the disk-shaped element body on the basis of the measured value of the electrostatic capacitance.

A multilayer coil component mounted in an optical communication module of the present disclosure is manufactured using the following method, for example.

Hereafter, an example in which a mixture of a ferrite material and a non-magnetic material is used as a material for the insulating layers is described, but alternatively only one out of a ferrite material and a non-magnetic material may be used as a material for the insulating layers.

Ferrite Material Manufacturing Process

Fe₂O₃, ZnO, CuO, and NiO are weighed so as to be at a prescribed ratio. These oxides may contain unavoidable impurities. Next, a slurry is prepared by wet mixing these weighed materials together and then pulverizing the materials. At this time, additives such as Mn₃O₄, Bi₂O₃, Co₃O₄, SiO₂, and SnO₂ may be added. The resulting slurry is dried and then preliminarily fired. The preliminary firing temperature is, for example, around 700° C. to around 800° C. A powdered ferrite material is manufactured in this way.

The ferrite material preferably contains Fe₂O₃ at around 40 mol % to around 49.5 mol %, ZnO at around 2 mol % to around 35 mol %, CuO at around 6 mol % to around 13 mol %, and NiO at around 10 mol % to around 45 mol %.

Non-Magnetic Material Manufacturing Process

A non-magnetic material powder is weighed. When a mixture of borosilicate glass powder and forsterite powder is used as the non-magnetic material, a glass powder containing potassium, boron, silicon, and aluminum in a prescribed ratio is prepared as the borosilicate glass. In addition, forsterite powder is prepared.

The borosilicate glass preferably contains Si at a ratio of around 80 wt % to around 85 wt % in terms of SiO₂, B at a ratio of around 10 wt % to around 25 wt % in terms of B₂O₃, an alkali metal A at a ratio of around 0.5 wt % to around 5 wt % in terms of A₂O, and Al at a ratio of around 0 wt % to around 5 wt % in terms of Al₂O₃.

Green Sheet Manufacturing Process

The ferrite material and the non-magnetic material are weighed in a prescribed ratio. Next, these weighed materials are mixed with an organic binder such as polyvinyl butyral resin, an organic solvent such as ethanol or toluene, a plasticizer, and so forth and then the mixture is pulverized to produce a slurry. The obtained slurry is then molded into a sheet of a prescribed thickness using a doctor blade method or another method and then punched into a predetermined shape to produce green sheets.

The thickness of the green sheets is preferably around 20 μm to around 30 μm.

The ferrite material and the non-magnetic material are preferably mixed while adjusting the volume ratio of the ferrite material and the non-magnetic material so that the ratio of the volume of the non-magnetic material to the total volume of the ferrite material and the non-magnetic material is around 50 vol % to around 80 vol %.

Conductor Pattern Forming Process

First, via holes are formed by performing laser irradiation at prescribed locations on the green sheets.

Next, a conductive paste such as a silver paste is applied to the surfaces of the green sheets while filling the via holes by using a screen printing method or the like. Thus, coil-conductor conductor patterns, which are connected to via-conductor conductor patterns, are formed on the surfaces of the green sheets while forming the via-conductor conductor patterns inside the via holes in the green sheets. In this way, coil sheets are manufactured in which the coil-conductor conductor patterns and the via-conductor conductor patterns are formed on and in the green sheets. A plurality of the coil sheets are manufactured and coil-conductor conductor pattern corresponding to the coil conductors illustrated in FIGS. 5 and 6 and via-conductor conductor patterns corresponding to the via conductors illustrated in FIGS. 5 and 6 are formed on and in the coil sheets.

In addition, separately from the coil sheets, via sheets are manufactured in which via-conductor conductor patterns are formed in the green sheets by filling the via holes in the green sheets with a conductive paste such as a silver paste using a screen printing method or the like. A plurality of the via sheets are manufactured and via-conductor patterns corresponding to the via conductors illustrated in FIGS. 5 and 6 are formed in the via sheets.

Multilayer Body Block Manufacturing Process

A multilayer body block is manufactured by stacking the coil sheets and the via sheets in the stacking direction in the order illustrated in FIGS. 5 and 6 and then subjecting the stacked sheets to thermal pressure bonding.

Multilayer Body and Coil Manufacturing Process

First, individual chips are manufactured by cutting the multilayer body block into pieces of a prescribed size using a dicer or the like.

Next, the individual chips are fired. The firing temperature is, for example, around 900° C. to around 920° C. Furthermore, the firing time is around 2 hours to around 8 hours, for example.

By firing the individual chips, the green sheets of the coil sheets and the via sheets become insulating layers. As a result, multilayer bodies in each of which a plurality of insulating layer are stacked in the stacking direction, in this case, length direction are manufactured. The ferrite phase and the non-magnetic phase are formed in the multilayer bodies.

The coil-conductor conductor patterns and the via-conductor conductor patterns of the coil sheets become the coil conductors and the via conductors when the individual chips are fired. As a result, coils are manufactured in which a plurality of coil conductors are electrically connected to each other by the via conductors while being stacked in the stacking direction.

In this way, a multilayer body and a coil provided inside the multilayer body are manufactured. The stacking direction of the insulating layers and the direction of the coil axis of the coil are parallel to the first main surface, which is the mounting surface, of the multilayer body and are parallel to the length direction in this case.

The via-conductor conductor patterns of the via sheets become the via conductors when the individual chips are fired. As a result, the first connection conductor and the second connection conductor are manufactured in which the plurality of via conductors are electrically connected to each other while being stacked in the length direction. The first connection conductor is exposed from the first end surface of the multilayer body. The second connection conductor is exposed from the second end surface of the multilayer body.

The corner portions and edge portions of the multilayer body may be rounded by performing barrel polishing, for example.

Outer Electrode Forming Process

First, a conductive paste containing silver and glass frit is applied to the first end surface and the second end surface of the multilayer body. Next, the base electrode layers are formed on the surfaces of the multilayer body by baking the resulting coatings. More specifically, a base electrode layer is formed so as to extend from the first end surface of the multilayer body across part of the first main surface, part of the second main surface, part of the first side surface, and part of the second side surface. In addition, a base electrode layer is formed so as to extend from the second end surface of the multilayer body across part of the first main surface, part of the second main surface, part of the first side surface, and part of the second side surface. The baking temperature of the coatings is around 800° C. to around 820° C., for example.

After that, a nickel coating and a gold coating are sequentially formed on the surface of each base electrode layer by performing electrolytic plating or the like.

Thus, the first outer electrode that is electrically connected to the coil via the first connection conductor and the second outer electrode that is electrically connected to the coil via the second connection conductor are formed.

Thus, the multilayer coil component is manufactured. Gold coatings are located at the outermost layers of the first outer electrode and the second outer electrode of the multilayer coil component.

An optical communication module of the present disclosure can be obtained by mounting the multilayer coil component manufactured using the above procedure on a substrate provided with lands whose surfaces are formed of gold layers.

The multilayer coil component can be mounted on a substrate by applying solder paste containing gold-tin solder to the lands whose surfaces are formed of gold layers, placing the multilayer coil component so that the outer electrodes, which include gold coatings in their outermost layers, contact the solder paste, and then performing a reflow process.

The reflow conditions can be those normally used for bonding using gold-tin solder.

Other electronic components included in the optical communication module can be mounted at the same time as the multilayer coil component by performing a reflow process using the same procedure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An optical communication module comprising:
a substrate equipped with lands whose surfaces include gold layers; and
a multilayer coil component that is mounted on the substrate,
wherein the multilayer coil component includes a multilayer body in which a plurality of insulating layers are stacked in a stacking direction, a coil inside the multilayer body, and outer electrodes on surfaces of the multilayer body and electrically connected to the coil,
the outer electrodes include gold coatings located at outermost layers of the outer electrodes, and
the gold coatings of the outer electrodes are bonded to the gold layers of the lands of the substrate via gold-tin solder.

2. The optical communication module according to claim 1, wherein
an electronic component other than the multilayer coil component is mounted on the substrate and the electronic component and the multilayer coil component are mounted adjacent to each other.

3. The optical communication module according to claim 2, wherein
the electronic component mounted adjacent to the multilayer coil component is an IC.

4. The optical communication module according to claim 1, wherein
in the multilayer coil component,
the multilayer body has a first end surface and a second end surface, which face each other in a length direction, a first main surface and a second main surface, which face each other in a height direction perpendicular to the length direction, and a first side surface and a second side surface, which face each other in a width direction perpendicular to the length direction and the height direction,
the outer electrodes include a first outer electrode that extends from at least part of the first end surface of the multilayer body across part of the first main surface and a second outer electrode that extends from at least part of the second end surface of the multilayer body across part of the first main surface,
the first main surface is a mounting surface, and
the stacking direction of the multilayer body and a coil axis of the coil are parallel to the mounting surface.

5. The optical communication module according to claim 1, wherein
a thickness of each gold coating is from 0.4 μm to 1.2 μm.

6. The optical communication module according to claim 1, wherein
each outer electrode includes a nickel coating located nearer the multilayer body than the gold coating.

7. The optical communication module according to claim 6, wherein
a thickness of each nickel coating is from 1.5 μm to 4.5 μm.

8. The optical communication module according to claim 1, wherein
each outer electrode includes a base electrode layer that includes silver and contacts the multilayer body.

9. The optical communication module according to claim 1, wherein
the insulating layers include a ferrite phase and a non-magnetic phase, which is composed of a material having a lower dielectric constant than a ferrite material constituting the ferrite phase.

10. The optical communication module according to claim 9, wherein
a ratio of a volume of the non-magnetic phase to a total volume of the ferrite phase and the non-magnetic phase is from 55 vol % to 80 vol %.

11. The optical communication module according to claim 9, wherein
a ratio of a volume of forsterite to a total volume of the non-magnetic phase is from 2 vol % to 8 vol %.

12. The optical communication module according to claim 1, wherein
the insulating layers contain
B at 4.3 wt % to 8.0 wt % in terms of B₂O₃,
Si at 27.6 wt % to 51.4 wt % in terms of SiO₂,
Mg at 1.1 wt % to 2.1 wt % in terms of MgO,
Fe at 24.7 wt % to 43.5 wt % in terms of Fe₂O₃,
Ni at 3.3 wt % to 5.9 wt % in terms of NiO,
Zn at 7.7 wt % to 13.5 wt % in terms of ZnO, and
Cu at 2.0 wt % to 3.6 wt % in terms of CuO.

13. The optical communication module according to claim 2, wherein
in the multilayer coil component,
the multilayer body has a first end surface and a second end surface, which face each other in a length direction, a first main surface and a second main surface, which face each other in a height direction perpendicular to the length direction, and a first side surface and a second side surface, which face each other in a width direction perpendicular to the length direction and the height direction,
the outer electrodes include a first outer electrode that extends from at least part of the first end surface of the multilayer body across part of the first main surface and a second outer electrode that extends from at least part of the second end surface of the multilayer body across part of the first main surface,
the first main surface is a mounting surface, and
the stacking direction of the multilayer body and a coil axis of the coil are parallel to the mounting surface.

14. The optical communication module according to claim 2, wherein
a thickness of each gold coating is from 0.4 μm to 1.2 μm.

15. The optical communication module according to claim 2, wherein
each outer electrode includes a nickel coating located nearer the multilayer body than the gold coating.

16. The optical communication module according to claim 2, wherein
each outer electrode includes a base electrode layer that includes silver and contacts the multilayer body.

17. The optical communication module according to claim 2, wherein
the insulating layers include a ferrite phase and a non-magnetic phase, which is composed of a material having a lower dielectric constant than a ferrite material constituting the ferrite phase.

18. The optical communication module according to claim 10, wherein
a ratio of a volume of forsterite to a total volume of the non-magnetic phase is from 2 vol % to 8 vol %.

19. The optical communication module according to claim 2, wherein
the insulating layers contain
B at 4.3 wt % to 8.0 wt % in terms of B₂O₃,
Si at 27.6 wt % to 51.4 wt % in terms of SiO₂,
Mg at 1.1 wt % to 2.1 wt % in terms of MgO,
Fe at 24.7 wt % to 43.5 wt % in terms of Fe₂O₃,
Ni at 3.3 wt % to 5.9 wt % in terms of NiO,
Zn at 7.7 wt % to 13.5 wt % in terms of ZnO, and
Cu at 2.0 wt % to 3.6 wt % in terms of CuO.

20. A multilayer coil component that is mounted in an optical communication module, the multilayer coil component comprising:
a multilayer body in which a plurality of insulating layers are stacked in a stacking direction, a coil inside the multilayer body, and outer electrodes on surfaces of the multilayer body and electrically connected to the coil,
wherein the outer electrodes include gold coatings located at outermost layers of the outer electrodes.
